(19) United States
(12) Patent Application Publication
(10) Pub. No.: US 2025/0000293 A1
(43) Pub. Date: Jan. 2, 2025

(54) BREWING CHAMBER HALF, BREWING UNIT, BEVERAGE PREPARATION MACHINE, METHOD FOR EJECTING A CAPSULE, AND BEREAGE PREPARATION SYSTEM

(71) Applicant: Delica AG, Buchs (CH)

(72) Inventors: Martin WÜTHRICH, Ziefen (CH); Patrick TSCHOPP, Riehen (CH); Roland AFFOLTER, Möriken (CH); Micha ZWEIFEL, Zürich (CH); Tim THILLA, Weil am Rhein (DE); Wolfgang RIESSBECK, Landschlacht (CH); Marco KELLER, Roggwil (CH); Patrick EGGER, Niederbüren (CH)

(73) Assignee: Delica AG, Buchs (CH)

(21) Appl. No.: 18/690,595

(22) PCT Filed: Aug. 23, 2022
(86) PCT No.: PCT/EP2022/073403

§ 371 Date: Mar. 8, 2024

(30) Foreign Application Priority Data
Sep. 10, 2021 (EP) 21196094.3

(51) Int. Cl. A47J 31/36

(52) U.S. Cl. CPC A47J 31/3638; A47J 31/3633

(57) ABSTRACT

Brewing chamber half (11, 12) for forming a brewing chamber (10) with a corresponding second brewing chamber half (12, 11) of a brewing unit (3) of a beverage preparation machine, the brewing chamber half (11, 12) having an inlet (23) for introducing a brewing liquid for preparing a beverage and/or an outlet (24) for discharging a prepared beverage. The brewing chamber half (11, 12) has at least one further access (25) for the introduction and/or discharge of a rinsing liquid.

The present disclosure relates to a brewing chamber half, a brewing unit, a beverage preparation machine, as well as a method for ejecting a capsule, and a beverage preparation system according to the headings of the independent claims.

Various capsule-based beverage preparation machines with brewing units and brewing chamber halves, as well as different methods for capsule management and beverage preparation are known from the prior art.

It is the task of the invention to overcome the disadvantages of the prior art. In particular, a system is to be provided which enables simple operation by a user.

This task is solved by the devices and methods defined in the independent patent claims. Further embodiments result from the dependent patent claims.

In the following, a capsule is understood to be a capsule for preparing a beverage or a liquid food. The capsule can comprise a capsule body which is filled with a substance for preparing a beverage. However, a capsule is also to be understood as a beverage substance which is encased in a shell. For example, the beverage substance can be compressed into a preferably spherical compact and coated with a shell material or enclosed in a loose shell. However, the capsule can also comprise a loose beverage substance in powder form, which is enclosed in a casing.

A brewing unit for a beverage preparation machine disclosed herein comprises at least first and second brewing chamber halves. The brewing chamber halves are arranged such that they are movable relative to each other from a closed position for forming a closed brewing chamber to an open position in which a capsule can be inserted into the brewing chamber. In this respect, the brewing unit has at least one, preferably two, holding means which hold a capsule in position in an intermediate open position between the first and second brewing chamber halves when the capsule is inserted and release it when the brewing chamber is closed. The first and second brewing chamber halves are spaced apart before the capsule is released by the holding means in such a way that the brewing chamber halves cannot grip a capsule, so that the capsule would fall through between the brewing chamber halves if it were not held by the holding means.

This spacing of the two brewing chamber halves ensures that a capsule can be easily removed from the brewing unit once the intermediate position has been reached. Only the holding means have to be moved apart to release the capsule. Accordingly, if the capsule is inserted into the brewing chamber by mistake, the capsule can be removed again and stored for later use.

The distance between the brewing chamber halves may be at least 10% greater than a largest dimension or diameter of a capsule intended for beverage preparation in the brewing unit before and/or after its extraction.

A spherical or polygonal capsule for preparing a coffee portion can have a largest dimension or diameter between 21 and 52 mm, preferably between 23 and 42 mm, particularly preferably between 25 and 30 mm. However, spherical or polygonal capsules with a largest dimension or diameter of 50 mm+/−10%, 26 mm+/−10% or 23 mm+/−10% are also conceivable, depending on the amount of beverage substance required for the beverage preparation.

The capsule can be guided and held in the intermediate position and before release by the holding means in such a way that it has no mechanical contact with the first brewing chamber half and/or the second brewing chamber half.

By avoiding mechanical contact or physical contact of the capsule with the brewing chamber halves, easy insertion of the capsule can be achieved. Likewise, it is thereby possible that a capsule can be removed from the brewing unit again after reaching the intermediate position without the capsule being damaged. Accordingly, if the capsule is inserted into the brewing chamber by mistake, the capsule can be removed again and stored without restriction for later use.

The brewing unit can have control means which, when the brewing chamber is closed, interact with the holding means in such a way that they release the capsule. Since the control means are directly connected to the brewing unit, a direct coupling of the movement of the brewing chambers with the holding means is easy to realise. Furthermore, the capsule does not have to be pushed out of the holding means, the holding means release the capsule automatically.

The holding means can be mounted so that they can swivel about an axis and/or can be moved in an axial direction. In order for the brewing chamber halves to move together, the holding means must be moved away from the area between the brewing chamber halves. By swivelling around an axis and/or a displacement in an axial direction, a simple moving away can be realised. At the same time, the axis can define the axial direction for the displacement. However, it is also conceivable that the displacement takes place along an axial direction which runs at an angle to the axis of the swivel movement. If the swivel axis is horizontal, at least the movement of the holding means in one direction can take place due to its gravitational force.

The holding means can be spoon-shaped. In this context, spoon-shaped means that the holding means are concave on the side associated with a capsule in the intended use, in order to be able to at least partially grip around and/or under the capsule. Thus, the capsule can be grasped and held in the corresponding intermediate position with only a slight engagement. It goes without saying that the concave design of the holding means must be adapted to the shape of the capsule to be used.

Conventional capsules are usually gripped by holding means on a circumferential flange. In contrast to this gripping at a flange, the present holding means can be designed in such a way that it can grip a capsule without defined holding points. For example, capsules without a flange can be held in the intermediate position by the holding means. Spherical or cube-shaped capsules are particularly conceivable. Likewise, capsules with any polyhedron shape or even cylindrical capsules can be gripped by the holding means. Spherical, cube-shaped or polyhedron-shaped capsules have the advantage that they do not have to be held aligned in the intermediate position.

The holding means can enclose the capsule laterally in the intermediate position. The holding means have a smallest distance from each other, which corresponds to a maximum of 90% of the capsule diameter measured in the area around the capsule. This ensures that the capsule, when held in the intermediate position, cannot slide between the holding means under any circumstances and fall out of the intermediate position. The capsule diameter in the area of the circumference is determined by a section through the capsule transverse to a direction of movement of the two brewing chamber halves relative to each other. The holding means preferably enclose the capsule in a range of at least 20° each. This ensures that the capsule can be securely held in the intermediate position.

The holding means can be pre-tensioned against each other on the axis by means of a spring element. This pretensioning of the spring force can be used to determine the force with which a capsule that has been mistakenly inserted in the intermediate position can be removed again from the intermediate position when not in use. For example, it may happen that a user mistakenly inserts an espresso capsule but would like to enjoy a long coffee. In conventional brewing units, the inserted capsule can only be removed from the brewing unit by closing the brewing chamber and opening it again. The user can therefore only prepare the espresso capsule with a larger amount of water, enjoy an espresso instead of a long coffee or remove the capsule from the brewing unit without extraction but pierced. However, if the holding means only hold the capsule in place by a slight pretension of the spring force against each other, the capsule can simply be pushed through the space between the brewing chambers. The capsule is not damaged or pricked in the process and can be reused.

Another aspect of the present disclosure relates to a method of inserting a capsule into a brewing unit of a beverage preparation machine. In this respect, the brewing unit comprises a first brewing chamber half and a second brewing chamber half, which are arranged to be displaceable relative to each other to form a brewing chamber. The brewing unit in turn has at least one, preferably two, holding means for holding and positioning the capsule. During the process, the capsule is held by the holding means or by the holding means in an intermediate position between the two brewing chamber halves. When the brewing chamber halves are moved together, the holding means release the capsule and the capsule is gripped and aligned by one or both of the brewing chamber halves. The brewing chamber halves move together to form a closed brewing chamber. The first and second brew chamber halves are spaced apart prior to release by the holding means such that the brew chamber halves cannot engage the capsule if it is released early by the holding means. The capsule would fall between the two brewing chamber halves if released early.

The capsule can thus be freely inserted into the intermediate position before the brewing chamber halves move together. A capsule that has been inserted by mistake, for example to prepare an espresso instead of a long coffee, can be removed again from the intermediate position. To do this, only the holding means must be overcome, for example by pushing the holding means apart.

The capsule may have no mechanical contact with the first and/or second brewing chamber halves before being released by the holding means.

Removal of an incorrectly inserted capsule from the intermediate position can thus be done without damaging the capsule. Accordingly, the user can later use the capsule “recovered” in this way without any restrictions.

When the brewing chamber halves are moved together, the holding means can shift on an axis in the axial direction, so that a distance between the holding means increases. An axial displacement is easy to realise and can be precisely controlled.

The holding means can move against a force of a spring element on the axis. The holding means are thus preloaded against each other, whereby a defined smallest distance can be provided between the holding means. By overcoming the spring force, a capsule held in the intermediate position by the holding means can be removed.

When the capsule is released, the holding means may pivot about an axis. The axis can be the same axis along which the holding means move. Alternatively, it can also be a different axis. A pivoting movement of the holding means simply removes them from the area between the brewing chamber halves so that the brewing chamber can be closed. The swivelling movement can take place about a horizontally arranged axis upwards or downwards. Likewise, it is conceivable that the axis is vertically aligned and the holding means swivel sideways. The holding means can perform only a swivelling movement or only a sliding movement. A combination of movements is also possible.

When the brewing chamber halves are moved apart, the holding means can swivel around the axis back into the position between the brewing chamber halves. In doing so, a capsule adhering to a brewing chamber half can be pushed away from the brewing chamber half. Preferably, such pivoting back occurs downwards so that the capsule is pushed away downwards from the area between the brewing chamber halves due to the force of gravity. The moment of swinging back into the position between the brewing chamber halves can be delayed, for example only after the brewing chamber halves have reached their open position.

Another aspect of the present disclosure relates to a beverage preparation machine having a brewing unit as described above.

Another aspect of the present disclosure relates to a beverage preparation system comprising a capsule and a brewing unit as described above.

Another aspect of the present disclosure relates to a brewing chamber half for forming a brewing chamber with a corresponding second brewing chamber half of a brewing unit of a beverage preparation machine. In this regard, the brewing chamber half comprises an inlet for introducing a brewing liquid for beverage preparation and/or an outlet for discharging a prepared beverage. Furthermore, the brewing chamber half has at least one further access for the introduction and/or discharge of a rinsing liquid. The further access is thereby preferably separate from the inlet and the outlet. In the case of a single further access, this preferably serves to introduce and discharge the rinsing liquid. In the case of two or more further accesses, the introduction and discharge can take place through separate accesses. The brewing unit can be designed as described above.

Such further access of the brewing chamber half allows easy cleaning and/or rinsing of the brewing chamber without the inlet and/or outlet for preparing the beverage coming into contact with the rinsing liquid.

The further access can have a filter element. By using a filter element, it can be prevented that disturbing particles are washed into the brewing chamber and later negatively influence the beverage preparation there. It also prevents larger components of the beverage preparation, such as coffee particles, from being flushed out through the further access and damaging, blocking or obstructing any downstream valves.

The brewing chamber half can have an ejector for ejecting the capsule, which is designed to be movable relative to the brewing chamber half. This allows any capsule adhering to a brewing chamber half to be ejected after the beverage has been prepared and after the brewing chamber has been opened. Such an ejector is particularly useful when the capsule is pierced by perforation means attached to the brewing chamber half. Conventional capsules with a flange can be gripped at the flange and separated from the perforation means. In the case of capsules without a stable flange or without a flange at all, a pierced capsule will stick to the perforation means and can then be moved away from them or stripped off with the aid of the ejector. An ejector is also helpful for separating the capsule from the brewing chamber half or the perforation means in the case of capsules with a shell, for example made of cellulose or alginates.

The further access can be formed between the ejector and the brewing chamber half or open out between them. The movement of the ejector relative to the brewing chamber half ensures that the further access is constantly self-cleaning.

The filter element can be designed as a gap, preferably an annular gap, between the ejector and the brewing chamber half. The gap is preferably dimensioned in such a way that no beverage substance can penetrate into the gap. The aforementioned movement between the ejector and the brewing chamber half actively prevents particles of the beverage substance from jamming in the gap.

The gap can have a typical width of 200 μm, in particular the width of the gap is between 50 μm and 500 μm, preferably between 100 μm and 350 μm, particularly preferably between 150 μm and 250 μm. This dimensioning particularly prevents the penetration of coffee particles, which can arise during the extraction of a coffee capsule.

The brewing chamber half may have perforation means for perforating an inlet side or an outlet side of a capsule. The perforation means serve to pierce the capsule shell so that an extraction fluid can be introduced into or discharged from the capsule. The perforation means are preferably arranged to be movable relative to the brewing chamber half. The movable arrangement of the perforation means allows the timing of the piercing of a capsule to be deliberately controlled independently of the closing of the brewing chamber. For example, it is possible to arrange the perforation means on the outlet side of the capsule in such a way that they do not protrude into the brewing chamber. For example, the perforation means can be covered by the ejector on the outlet side. Accordingly, in a first extraction step, the capsule can first be pierced on the inlet side so that the beverage substrate to be extracted is wetted. Only in a subsequent step is the capsule opened, pierced or perforated on the outlet side. In this way, pressure can be built up in the capsule before the actual extraction. For example, this makes it possible to pre-brew a coffee substance before the coffee beverage is prepared. However, it is also conceivable that the perforation means pierce the capsule on the inlet side and outlet side at the same time. The perforation means are then exposed and are not covered by an ejector.

The ejector can be arranged so that it can move relative to the perforation means. This makes it possible to strip the capsule from the perforating means even if the perforating means is movable relative to the brewing chamber half.

The brewing chamber half can have at least one groove approximately in the centre, which runs from the ejector in the direction of the corresponding second brewing chamber half. Such a groove facilitates the detachment of the capsule from the surface of the brewing chamber or from the corresponding perforation means. A vacuum created between the wall of the brewing chamber and the capsule by retracting the perforation means or an injector plate and, if necessary, by opening the brewing chamber can thus be specifically prevented. No beverage substance is drawn out of the capsule through the openings created by the perforation means, which could contaminate the brewing chamber. This groove can absorb any residual water during extraction, so that the residual water supports the capsule in the area of the groove.

The groove can have a width of between 0.2 mm to 3.0 mm, preferably of 1.0 mm, and a depth of between 0.2 mm to 3.0 mm, preferably 1.0 mm. These dimensions have proven to be optimal in separating the capsule from the brewing chamber without negatively affecting the behaviour of the capsule in the brewing chamber during extraction.

Another aspect of the present disclosure relates to a brewing unit of a beverage preparation machine. The brewing unit comprises two corresponding brewing chamber halves. The brewing chamber halves are arranged to be movable relative to each other to be moved from an open position for dispensing and inserting a capsule to a closed position for forming a brewing chamber and enclosing and extracting the capsule. In this regard, at least one of the brewing chamber halves has an inlet for introducing a brewing liquid for preparing a beverage and at least one brewing chamber half has an outlet for discharging a prepared beverage. Furthermore, at least one brewing chamber half has at least one further inlet for introducing and/or discharging a rinsing liquid. The brewing unit can be designed as described above.

Such a further access in a brewing chamber half enables easy cleaning and/or rinsing of the brewing chamber without rinsing liquid getting into the inlet and/or outlet. The inlet and outlet can be located in the same half of the brewing chamber or in different halves of the brewing chamber. Likewise, the further access may be located at one half of the brewing chamber together with the inlet or the outlet, or the further access is located together with the inlet and outlet in the same half of the brewing chamber. Furthermore, the further access can be located in one half of the brewing chamber, while the inlet and outlet are located in the other half of the brewing chamber. If there are several further access points, these can be located in both brewing chamber halves.

At least one of the brewing chamber halves may have perforation means for perforating an inlet side or an outlet side of the capsule and an ejector for ejecting and stripping the capsule from the perforation means. In this case, the ejector is arranged to be movable relative to the brewing chamber half and/or to the perforation means. In the open position, the ejector covers the perforation means in such a way that they protrude at most insignificantly. Here and in the following, “protruding at most insignificantly” means that the perforation means do not obstruct or damage a capsule during insertion and/or ejection from the brewing chamber.

Another aspect of the present disclosure relates to a method of ejecting a capsule from a brewing unit, as previously described, of a beverage preparation machine. Upon relative movement of the brewing chamber halves from the closed position for forming a brewing chamber and enclosing and extracting the capsule to the open position for dispensing and inserting the capsule, in a first step the brewing chamber halves will move away from each other. In an at least partially simultaneous or subsequent further step, the perforation means will move relative to the ejector until they protrude at most insignificantly or no longer protrude at all. The relative movement between the ejector and the perforation means only when the brewing chamber is open can determine in which half of the brewing chamber the capsule remains and is only subsequently released. In addition, the perforation means can be designed in such a way that the capsule deliberately remains stuck on the perforation means. For example, barbs can be provided or perforation means have a neck that is thinner than the tip. Accordingly, the detachment from this perforation means must be consciously supported, for example by the ejector.

The ejector can move relative to the brewing chamber half in such a way that it protrudes from a surface of the brewing chamber half. This has the advantage that the capsule not only detaches from the perforation means, but is also detached from the brewing chamber half and pushed away at the same time.

The ejector can only move relative to the brewing chamber half when the brewing chamber halves are already in the open position or immediately before reaching the open position. This allows the capsule to exit directly from the area between the brewing chamber halves without any further contact with the brewing chamber halves. This prevents the capsule from sticking again or the brewing chamber halves from becoming dirty.

The ejector can move relative to the brewing chamber half in such a way that it does not protrude from the brewing chamber half. A fresh capsule can therefore be inserted unhindered.

Another aspect of the present disclosure relates to a beverage preparation machine having a brewing unit as described above.

Another aspect of the present disclosure relates to a beverage preparation system comprising a capsule and a brewing unit as described above.

Another aspect of the present disclosure relates to a beverage preparation machine comprising a brewing unit, in particular as described above, a pump, a first and a second fluid conduit, and a controller. The brewing unit comprises two corresponding brewing chamber halves which are arranged to be movable relative to each other. The brewing chamber halves can be moved from an open position for dispensing and inserting a capsule to a closed position for forming a brewing chamber and enclosing and extracting the capsule. In this case, the brewing chamber has an inlet for introducing an extraction liquid, an outlet for discharging the prepared beverage and at least one further access for rinsing the brewing chamber. The further access is separate from the inlet and the outlet. The pump is used to deliver the extraction or rinsing fluid. The first fluid line is arranged between the pump and the inlet and has a first valve for opening and closing the first fluid line. The second fluid line is arranged between the pump and the at least one further inlet and is provided with a second valve for opening and closing the second fluid line. At least one of the valves and/or the pump is controllable with the control.

The further access of the brewing chamber enables easy cleaning and/or rinsing of the brewing chamber without the need to supply rinsing liquid to the brewing chamber through the inlet and/or outlet and/or to discharge it from the brewing chamber.

The beverage preparation machine may comprise a third fluid conduit between the at least one further access and a collection container with a third valve for opening and closing the third fluid conduit. Such a third fluid line with the corresponding valve allows the rinsing liquid to be discharged from the brewing chamber into the collection container. Thus, the rinsing fluid does not have to flow out via the outlet of the brewing chamber.

The first and/or second and/or third valve can be actively controlled by the control unit. Solenoid valves or motor valves are conceivable for this purpose. Thus, for example, when filling the brewing chamber with a rinsing liquid, the second valve can be opened while the third valve remains closed. After a reaction time, the second valve can be closed and the third valve can be opened to drain off the rinsing liquid.

The first valve can be designed as a self-opening pressure valve. This can ensure that no rinsing liquid gets into the first fluid line and into a capsule inserted in the brewing chamber. The rinsing liquid can thus be injected under pressure into the brewing chamber via the at least one further access, as long as the pressure remains below the pressure required to open the first valve.

The first valve can have a hysteresis and open in particular at a pressure between 3 bar to 14 bar, preferably between 5 bar to 12 bar, particularly preferably between 7 bar to 9 bar, and close in particular at a pressure between 0.5 bar to 5.0 bar, preferably at 2 bar. There should be a pressure gradient between the opening pressure and the closing pressure of at least 1 bar. Such a hysteresis ensures that the extraction only starts at a certain pressure and stops again at a low pressure. A dripping of the extraction liquid into the brewing chamber can be avoided. Such a hysteresis can of course also be formed via the control system with an actuated first valve. A controlled valve allows a switching point to be defined independently of the pressure applied. The process sequence can thus be freely designed. In addition, defined intermediate positions can also be realised.

The beverage preparation machine may have a fourth valve for opening and closing a beverage outlet. The beverage outlet is understood to be a fluid line that extends from the outlet of the brewing chamber to a dispensing opening of the beverage preparation machine. For example, the fourth valve can be a self-opening pressure valve, which in particular opens at a pressure of between 1 bar to 12 bar, preferably between 3 bar to 10 bar, particularly preferably between 6 bar to 9 bar. Such a valve allows beverage extraction only from a preset pressure. For the preparation of a coffee, for example, it is important that the extraction takes place under a certain pressure. Otherwise, the coffee will have a noticeable loss of quality. It also prevents any rinsing liquid from flowing from the beverage outlet to the dispensing opening and thus into a cup provided by a user. This valve also allows a volume of air trapped in the brewing chamber to be compressed so that the closed brewing chamber can be filled with rinsing liquid and emptied again. The fourth valve can also be a valve that is actively controlled by the control unit.

The beverage preparation machine may comprise a hydraulic pressure piston with an injector plate, the injector plate being part of a brewing chamber half. This pressure piston is arranged between the pump and the first valve in such a way that the pressure piston moves the injector plate and thus a part of a brewing chamber half. This reduces the volume of the brewing chamber before the first valve opens. A capsule enclosed in the brewing chamber is deformed. Particularly in the case of a capsule which comprises a compact, deformation of the capsule is necessary in order to be able to break up the beverage substance compressed in the compact. Only in this way can a uniform extraction of the beverage substance take place. The hydraulic force of the plunger can be determined by the effective diameter of the plunger and the pressure required to open the first valve. The shape and the movement of the injector plate can be adapted to a capsule received in the brewing chamber in such a way that a breaking up of the beverage substrate of the capsule is achieved. This may involve introducing a crack structure or other, for example perforations, into part of a shell or surface material of the capsule. At the same time or alternatively, the injector plate may also serve to compact the beverage substrate so that it has a uniform density suitable for extraction.

The contact pressure piston can increase the contact pressure of the two brewing chamber halves against each other. Accordingly, less force can be used to close the brewing chamber while maintaining the sealing effect. The movement of the brewing chamber halves is considerably relieved.

Another aspect of the present disclosure relates to a method of preparing a beverage with a beverage preparation machine, in particular as previously described, comprising the steps of:
a) Inserting a capsule into the brewing chamber,
b) Closing the brewing chamber,
c) Filling the brewing chamber with a rinsing liquid through a further access,
d) Draining the rinsing liquid from the brewing chamber to a collection container,
e) Introducing an extraction liquid into the brewing chamber through an inlet, which is different from the further access, so that it flows into the capsule.

Such a process can be used to wet a capsule in the brewing chamber without the rinsing liquid coming into contact with the prepared beverage. For example, a capsule shell, which is in particular hygroscopic, can be wetted. At most, the physical properties of the capsule shell can be influenced. For example, the capsule can be perforated more easily by contact with the rinsing liquid. It is also conceivable that the elasticity or extensibility of the capsule shell is increased, in particular when rinsing with a hot rinsing liquid.

Steps c) and d) can be repeated once, twice, three times or several times. Depending on the material of the capsule shell and the effect to be achieved, several repetitions can take place.

Steps d) and e) can be carried out at least partially simultaneously. In particular, in the case of a flexible capsule shell, a drainage of the rinsing liquid from the brewing chamber is assisted by an expansion of the volume of the capsule when injecting the extraction liquid into the capsule.

Before the extraction liquid is introduced into the capsule, the size of the brewing chamber can be reduced and the capsule deformed. For this purpose, it is advantageous if the capsule shell is designed to be flexible and stretchable so that the shell does not break open and the beverage substance is not released. In particular, if the capsule comprises a compact, reducing the volume of the brewing chamber allows the compact to be broken up so that a uniform extraction can subsequently take place. The size and shape of the brewing chamber may be adapted to a capsule received in the brewing chamber such that break-up of the beverage substrate of the capsule is achieved. This may involve introducing a crack structure or other, for example perforations, into a portion of a shell or surface material of the capsule. At the same time or alternatively, the reduction in brewing chamber volume may also serve to compact the beverage substrate so that it has a uniform density suitable for extraction.

During the introduction of the extraction liquid through the inlet into the capsule, the volume of the capsule can expand. Reducing the size of the brewing chamber already allows the capsule to adapt to its volume. However, when the extraction liquid is introduced, this adaptation of the capsule volume to the volume of the brewing chamber is further increased. The capsule is pressed against the wall of the brewing chamber by the pressure prevailing inside the capsule.

Another aspect of the present disclosure relates to a beverage preparation system comprising a capsule and a beverage preparation machine as described above.

Another aspect of the present disclosure relates to a brewing unit, in particular as previously described, of a beverage preparation machine having a brewing chamber and a brewing chamber surface. The brewing chamber is formed substantially rotationally symmetrical with respect to an axis directed from a first brewing chamber half to a second brewing chamber half. In the direction of the axis, the brewing chamber has a maximum axial extension which is smaller than the largest diameter of the brewing chamber transverse to the axis. In the area of the axis, the brewing chamber has a thickness which is equal to or smaller than the axial expansion.

Such a shape of the brewing chamber has proven to be advantageous for the uniform extraction of a beverage substance.

The brewing chamber surface is understood here and in the following to be the outer surface of the space enclosed by the brewing chamber, excluding recesses for penetration means for piercing the capsule or small depressions or grooves with a width of up to 3 mm.

The brewing chamber can have a reduced thickness on both sides in the area of the axis. The extraction quality is further improved by the reduced thickness on both sides.

A brewing unit of a beverage preparation machine disclosed here with a brewing chamber and a brewing chamber surface, in particular as described above, is designed to be essentially rotationally symmetrical with respect to an axis directed from a first brewing chamber half to a second brewing chamber half. In the region of the axis, the brewing chamber surface has a concave recess on at least one side, preferably on both sides, and is convex in the region transverse to the axis.

The concave-convex design of the brewing chamber ensures optimal extraction of a correspondingly shaped capsule.

The brewing chamber surface can have a steady curvature. By avoiding abrupt changes in direction and edges, a uniform extraction can be ensured. Furthermore, a capsule received in the brewing chamber can be safely deformed and adapted to the shape of the brewing chamber.

The brewing chamber surface can have a minimum radius of curvature of 3 mm. Again, this avoids abrupt changes in direction and edges.

Less than 50%, preferably less than 30%, particularly preferably less than 20%, of the brewing chamber surface can be formed as a flat surface. Although such flat surfaces are conceivable, the aim is to achieve as “round” a surface as possible so that extraction can take place optimally. Of course, a “round” surface can also be achieved from a plurality of polygons. In this case, however, a minimum angle between two touching polygon surfaces of 150°, preferably 160°, particularly preferably 170°, would have to be observed.

The brewing unit may have two corresponding brewing chamber halves which are movable relative to each other to move from an open position for dispensing and inserting a capsule to a closed position for forming the brewing chamber and enclosing and extracting the capsule. In this regard, both the first and second brewing chambers may be movably arranged. Likewise, it is conceivable that both brewing chamber halves are movably arranged.

The brewing chamber can have a maximum axial extension in the direction of the axis in the range between 15 mm to 42 mm, preferably between 18 mm to 32 mm, particularly preferably between 20 mm to 26 mm. Typically, the maximum extension is 22 mm.

The brewing chamber may have a largest diameter of the brewing chamber transverse to the axis in the range between 25 mm to 65 mm, preferably between 28 mm to 50 mm, more preferably between 30 mm to 35 mm. Typically, the largest diameter is 32 mm.

The brewing chamber may have a reduced thickness in the region of the axis in the range between 12 mm to 40 mm, preferably between 14 mm to 32 mm, more preferably between 15 mm to 20 mm. Typically, the reduced thickness is 17 mm.

These dimensions can also vary. However, it has been shown that for optimal extraction, an axial dimension should be smaller than a largest diameter and a thickness should be smaller than the axial dimension.

Another aspect of the present disclosure relates to a beverage preparation machine having a brewing unit as described above.

Another aspect of the present disclosure relates to a beverage preparation system comprising a capsule and a brewing unit as described above.

With reference to figures, which are merely examples of embodiments, the disclosed invention is explained in more detail below. They show:

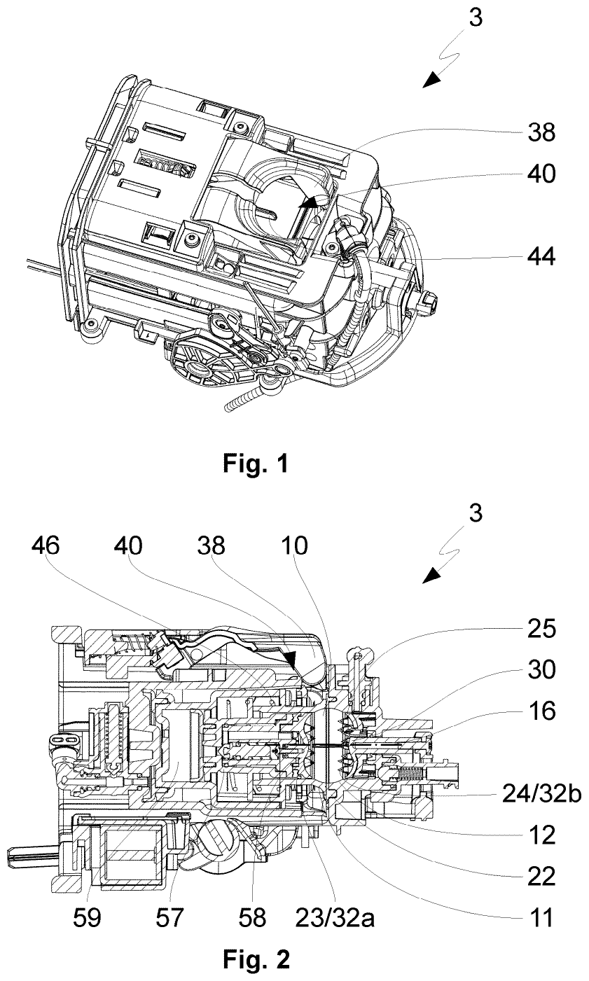

FIG. 1: A perspective view of a brewing unit with a closed brewing chamber, seen from above,

FIG. 2: A section through the brewing unit according to FIG. 1,

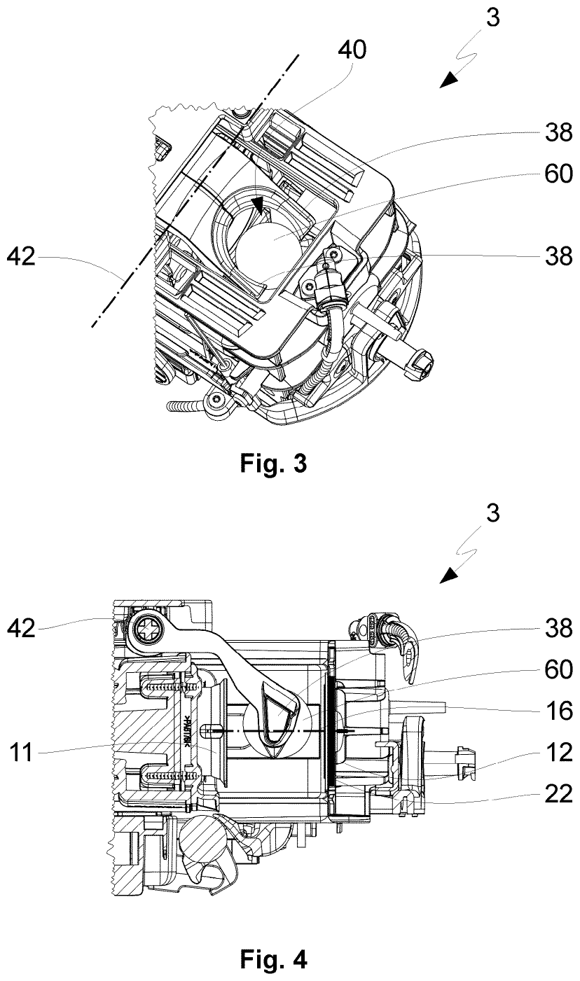

FIG. 3: A perspective view of a brewing unit with an open brewing chamber, seen from above,

FIG. 4: A section through the brewing chamber according to FIG. 3,

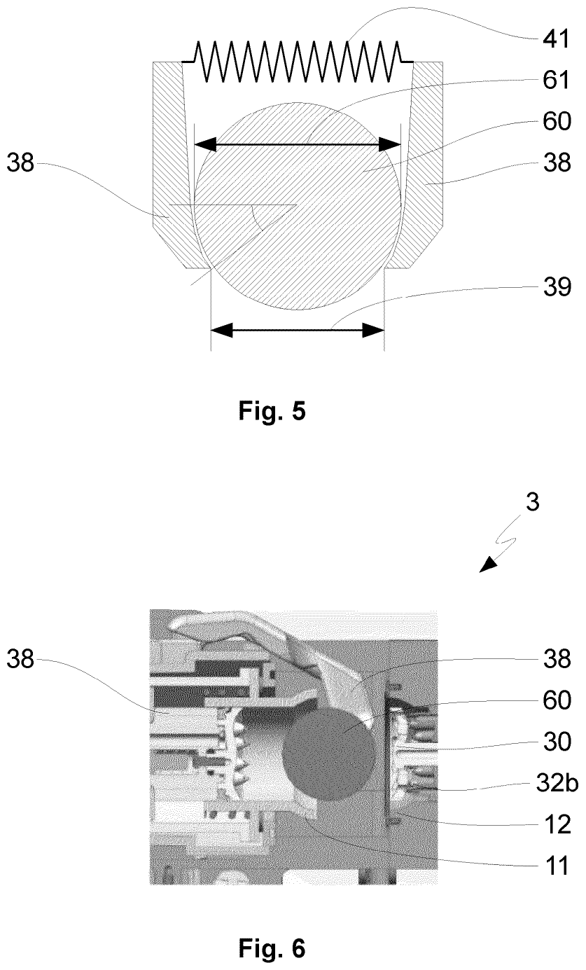

FIG. 5: a schematic representation of a capsule in an intermediate position,

FIG. 6: The brewing unit of FIG. 4 in a longitudinal section, whereby the brewing chamber is no longer completely open,

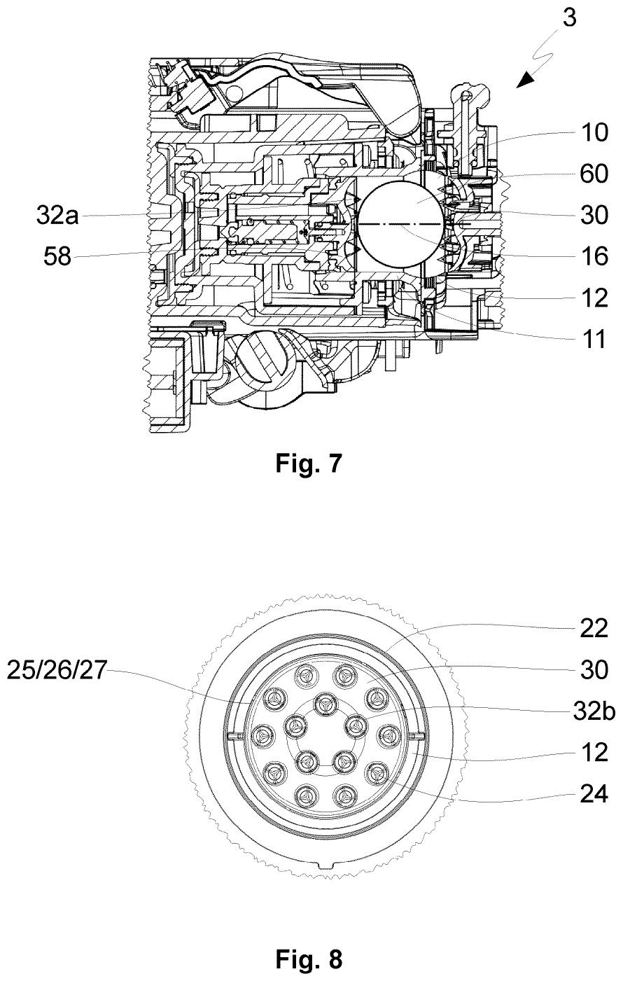

FIG. 7: the brewing unit of FIG. 4 in longitudinal section, with the brewing chamber closed,

FIG. 8: A perspective view of a brewing chamber half with ejector and perforation means,

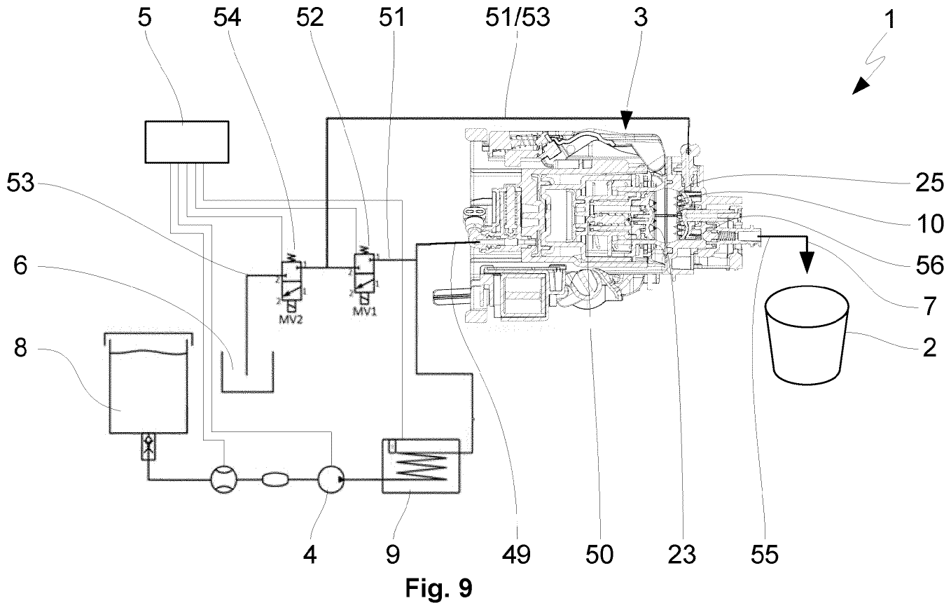

FIG. 9: a representation of the hydraulic diagram of the brewing unit,

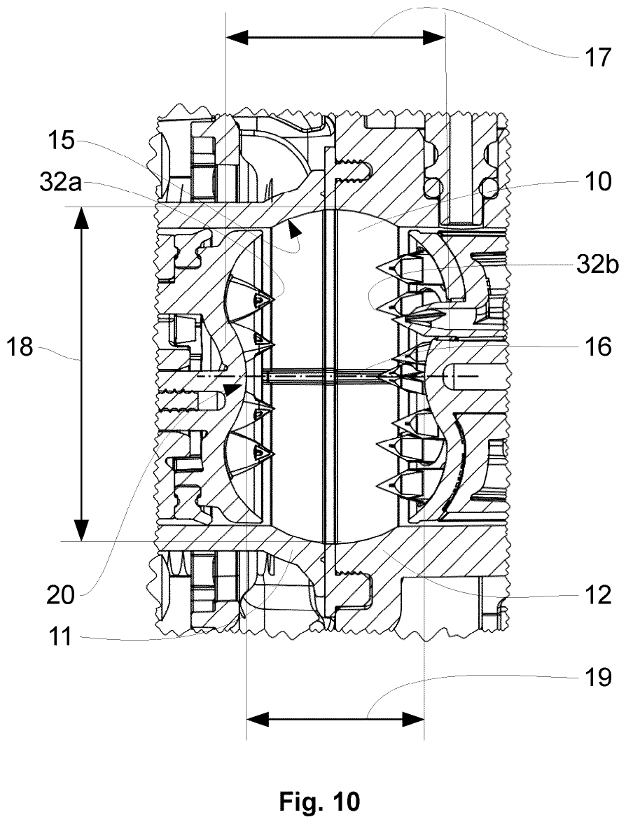

FIG. 10: a section through the closed brewing chamber of the brewing unit.

FIG. 1 shows a perspective view of an embodiment of a brewing unit 3 for a beverage preparation machine, whereby the brewing chamber of the brewing unit 3 is closed. An insertion shaft 40 can be seen on the upper side of the brewing unit 3, which is delimited on both sides by a holding means 38. A capsule 60 (see FIG. 3) can be inserted into this insertion shaft 40 when the brewing chamber is open.

FIG. 2 shows a longitudinal section of the brewing unit 3 from FIG. 1. Again, the feed chute 40 and a holding means 38, which laterally limits the feed chute 40, can be seen. A brewing chamber 10 is arranged below the feed chute 40, which is closed in the illustration shown. The brewing chamber 10 comprises a first brewing chamber 11 and second brewing chamber half 12, which are movable relative to each other from an open position, in which the capsule 60 (see FIG. 3) can be inserted between the brewing chamber halves 11 and 12, to the closed position shown. It is irrelevant which of the two brewing chamber halves 11, 12 moves. Likewise, both brewing chamber halves 11, 12 can be designed to be movable. The movement of the brewing chamber halves 11, 12 relative to each other define an axis 16, which is directed from the first brewing chamber 11 to the second brewing chamber 12.

The brewing chamber 10 has an inlet 23 in the first brewing chamber half 11 to allow an extraction fluid to be introduced into the brewing chamber 10 and into the capsule 60 (see FIG. 3). The inlet 23 opens into the tips of individual perforation means 32a of an injector plate 58. In addition, the brewing chamber 10 has an outlet 24 in the second brewing chamber half 12 to allow a prepared beverage to be discharged from the brewing chamber 10. The outlet 24 is formed in the second brewing chamber half 12 by openings to the hollow perforation means 32b. A further access 25 opens into the brewing chamber 10, through which a rinsing liquid can be introduced into the brewing chamber 10 and removed therefrom. This further access 25 is formed between the ejector 30 and the fixed part of the second brewing chamber half 12 as an annular gap 27 (see FIG. 8). The annular gap 27 is dimensioned in such a way that it serves as a filter element 26 (see FIG. 8) to prevent residues from being flushed out of the brewing chamber 10 through the further access 25. The annular gap has a width of 200 μm. A sealing element 22 is arranged between the two halves of the brewing chamber 11 and 12, which facilitates a tight closure of the brewing chamber 10.

FIGS. 3 and 4 show the brewing unit 3 with the brewing chamber 10 in the open position, a spherical capsule 60 being held in an intermediate position between the brewing chamber halves 11 and 12 by the holding means 38.

FIG. 5 shows schematically the two holding means 38 which hold the capsule 60. In the intermediate position, the capsule 60 is not in contact with the brewing chamber halves 11 and 12 but lies freely in this intermediate position apart from the holding means 38. The holding means 38 are spoon-shaped and enclose the capsule 60 in an angular range of 28° each. Accordingly, the smallest distance 39 between the holding means 38 is 16% smaller than the capsule diameter 61. Thus, the capsule 60 cannot slip between the holding means 38. When the brewing chamber 10 is open, the holding means 38 are relatively pretensioned against each other by at least one spring element 41, as can be seen schematically in FIG. 5.

As soon as the brewing chamber halves 11 and 12 move relative to each other and are only at a distance from each other which is less than the dimensions of the capsule 60, in this case a spherical capsule, i.e. less than its diameter 61 (see FIG. 5), the holding means 38 are moved apart relative to each other against the spring force of the spring element 41 so that the capsule 60 is dropped. This movement of the holding means 38 apart is effected by a control means 44 (see FIG. 1), which pushes itself wedge-shaped between the holding means 38 and thus increases their distance. The holding means 38 can also swivel around an axis 42, which is shown in FIGS. 3 and 4. The spring element 41 is preferably also arranged on this axis 42, so that the spring force acts along this axis 42. The pivoting movement completely removes the holding means 38 from the area between the brewing chamber halves 11, 12. The brewing chamber halves 11 and 12 moving together are accordingly not hindered by the holding means 38. At the same time, the brewing chamber halves 11 and 12 catch the capsule 60 (see FIG. 6) and align it so that it lies between the two brewing chamber halves 11 and 12 when the brewing chamber 10 is closed (see FIG. 7).

While the brewing chamber halves 11 and 12 are moving together, the injector plate 58 in the first brewing chamber half 11 is set back so that the capsule 60 has sufficient clearance between the brewing chamber halves 11 and 12. The perforation means 32b of the second brewing chamber half 12 are covered by the projecting ejector 30 so that the capsule 60 is not hindered in its movement by these.

As can be seen in FIG. 7, when the brewing chamber 10 is closed, the ejector 30 of the second brewing chamber half 12 is retracted again so that the perforation means 32b protrude from the ejector 30 and contact the capsule 60. The injector plate 58 of the first brewing chamber half 11 is still recessed, the corresponding piercing mandrels of the injector plate 58 merely touch the capsule 60.

FIG. 8 shows an enlarged view of the second half of the brewing chamber 12 with the circumferential sealing element 22. The ejector 30, which is movably mounted in the brewing chamber half 12, is clearly visible. Also visible are the perforation means 32b, which protrude from the ejector 30. The perforation means 32b are designed as a hollow cannula and have inlet openings which form the outlet 24 of the brewing chamber. An annular gap 27 is formed between the ejector 30 and the second brewing chamber half 12, which extends around the ejector 30. On the one hand, this annular gap 27 forms the further access 25 to the brewing chamber to be able to pressurise it with a rinsing liquid. By means of a suitable dimensioning of the gap 27, it also serves as a filter element 26 to prevent an unintentional introduction of foreign bodies into the brewing chamber as well as a flushing out of residual substances from the brewing chamber. In the embodiment shown, the annular gap 27 has a width of 200 μm.

FIG. 9 shows a diagram of the hydraulic system of a beverage preparation machine 1 with a brewing unit 3 as described above. In addition to the brewing unit 3, the beverage preparation machine 1 also has a tank 8 or a fresh water connection. Both the extraction liquid and the rinsing liquid are provided from this tank 8 or fresh water connection. A pump 4 is used to deliver the extraction liquid and the rinsing liquid. A heating element 9 heats the water to the temperature required for the extraction of the desired beverage.

A first fluid line 49 leads from the pump 4 or the heating element 9 to the inlet 23 of the brewing chamber 10. A first valve 50 is arranged between the pump 4 and the inlet 23. This valve 50 is designed as a pressure valve and ensures that the extraction fluid can only pass through the first valve 50 after a preset pressure has been exceeded. It also ensures that a hydraulic pressure piston 57 (see FIG. 2) generates a sufficiently large force with its effective diameter so that the hydraulic pressure piston 57 can move. Furthermore, this pressure valve prevents a liquid from flowing back from the brewing chamber 10 into the heating element 9 or the pump 4.

A second fluid line 51 leads from the pump 4 or the heating element 9 to the further access 25 of the brewing chamber. A second valve 52 is arranged between the pump 4 and the further access 25. Through this second valve 52, the further access 25 and the brewing chamber 10 can be provided with a rinsing liquid, for example to wet a capsule 60 inserted in the brewing chamber (see FIG. 7). At the same time, the second valve 52 ensures that no rinsing liquid can flow back into the heating element 9 or the pump 4 when the pump 4 is switched off.

A third fluid line 53 connects the further access 25 of the brewing chamber 10 with a collection container 6. The third fluid line has a third valve. This ensures that the rinsing fluid is first fed into the brewing chamber 10 before it is expelled into the collection container 6 after closing the second valve 52 and opening the third valve 54.

Starting from the outlet 24 (see FIG. 8), another fluid line leads as a beverage outlet 55 to a dispensing opening 7 of the beverage preparation machine. In the embodiment shown, a fourth valve 56 is arranged in this beverage outlet 55, which in turn is designed as a pressure valve. The fourth valve prevents the rinsing liquid, which is supplied under pressure to the brewing chamber 10, from flowing through the beverage outlet into a cup 2 for holding a beverage desired by a user. Since a certain volume of ambient air is also enclosed in the closed brewing chamber 10 prior to rinsing, in addition to the capsule 60, the fourth valve 56 enables compression of this air volume and thus improved wetting of the capsule 60. Furthermore, this fourth valve 56 can ensure that the preparation of the beverage only takes place from a preset pressure, which contributes significantly to the quality, particularly when preparing coffee.

The beverage preparation machine 1 also has a control 5 which controls the pump 4, the heating element 9 and the second and third valves 52, 54. Of course, the control 5 can also be connected to sensors, for example a flow meter, a temperature sensor, etc., whose signals contribute to the control. Also, for example, the movement of the brewing chamber halves 11, 12 can be monitored by the control 5 or even triggered by means of suitable drives.

To prepare a beverage, the brewing chamber 10 is closed after the capsule 60 has been inserted into the insertion chute 40. This is done by a relative movement of the two brewing chamber halves 11 and 12. In the embodiment shown, the first brewing chamber half 11 moves from the open position, as shown in FIGS. 3 and 4, via the half-open or half-closed position according to FIG. 6 to the closed position according to FIG. 7. The capsule 60 is first held by the two holding means 38 in the intermediate position between the two spaced brewing chamber halves 11 and 12 on the axis 16, directed from the first to the second brewing chamber half 11 and 12. As soon as the brewing chamber halves 11 and 12 approach each other, the two holding means 38 are pushed apart by the control means 44 against the spring force of the spring element 41. The capsule 60 falls onto a lower edge of the brewing chamber halves 11 and 12, which have already moved together somewhat. As the brewing chamber halves 11 and 12 move together further, the capsule is again aligned with the axis 16. The brewing chamber 3 can now be closed. With the aid of the sealing element 22, the two brewing chamber halves 11 and 12 form a closed and tight brewing chamber 3. In the first brewing chamber half 11, the injector plate 58 with its perforation means 32a is set back so far that they merely touch the capsule 60 but do not yet pierce it. In the second half of the brewing chamber 12, the ejector 30 is in a retracted position and releases the perforation means 32b. Also on this side, the capsule 60 is only touched by the perforation means 32b, but not yet perforated.

The control 5 switches on the heating element 9, opens the second valve 52 and releases the pump 4 to deliver approx. 10 ml of water. Since the first valve 50 only opens at a preset pressure, the water can thus only flow through the open second fluid line 51 to the further access 25 and into the brewing chamber 3. The water rinses the brewing chamber 3 and the capsule 60 enclosed in it is wetted. The second valve 52 is closed and the third valve 54 is opened. This opens the third fluid line 53. The rinsing water can escape from the brewing chamber 3 again. Since a certain volume of compressed air has been enclosed in the brewing chamber 3 in addition to the capsule, the escape of the rinsing water is facilitated. After approx. 1 s the third valve 54 is closed again, the access to the collection container 6 is thus closed. The second valve 52 is opened again to inject a further quantity of rinsing water into the brewing chamber 3. The brewing chamber 3 is flooded again and the capsule 60 is wetted again. After an action time of approx. 2 s, the second valve 52 closes and shortly afterwards the third valve 54 opens. Part of the rinsing water can again be discharged into the collection container 6.

The pump is activated when the second valve 52 is closed and delivers water. This can only spread in the first fluid line 49 up to the first valve 50. The water flows into an antechamber 59 of a hydraulic pressure piston 57, which is connected to the injector plate 58. The hydraulic pressure piston 57 is part of the first brewing chamber half 11. Since the first valve only opens from a preset pressure, in the shown embodiment example from 7 bar, the water delivered by the pump 4 will first drive the pressure piston 57 and thus the injector plate 58. However, this reduces the volume of the brewing chamber 3, the capsule 60 is deformed and pierced by the perforation means 32a and 32b of the first and second brewing chamber halves 11 and 12. This deformation of the capsule 60 is particularly important when the capsule 60 comprises a compact as a beverage substance. The deformation not only deforms the pressed product, but also breaks it open. The beverage substance can thus be extracted evenly. If the capsule contains a loose beverage substance, the injector plate also deforms the capsule. This compresses the loose beverage substance. Since the capsule 60 has been wetted with the preferably hot rinsing water prior to its deformation, the capsule shell has softened and can easily undergo the deformation. The capsule 60 adapts its shape to the shape of the brewing chamber 3 through the hydraulic pressing and expansion by the injected extraction liquid. Since the third valve 54 is still open until the capsule 60 is completely deformed, i.e. until the capsule shape is adapted to the shape of the brewing chamber 3, the rinsing water is displaced from the brewing chamber 3 and fed to the collection container 6 through the further access 25 and the third fluid line 53.

The pump 4 continues to deliver water even when the capsule 60 is completely deformed and the hydraulic pressure piston 57 has reached its end position. The pressure in the antechamber 59 increases further as a result. As soon as the preset pressure, in the shown embodiment example 7 bar, is reached, the first valve 50 opens and the first fluid line 49 is released up to the inlet 23. The perforation means 32a of the injector plate 30 are already pierced into the capsule 60, so that the water or extraction fluid is injected into the capsule 60 under high pressure. The extraction fluid enters the capsule 60, fills it and inflates it until the capsule 60 fills the brewing chamber 3. The pressure in the capsule 60 increases until the fourth valve 56 in the beverage outlet 55 opens. At this moment at the latest, the third valve 54 is closed. The extraction liquid passes through the capsule 60 from its inlet side to the opposite outlet side, where it is discharged from the brewing chamber as a prepared beverage through the outlet in the perforation means 32b. The beverage flows through the beverage outlet 55 to the dispensing opening 7, where it is dispensed into the cup 2. The fourth valve 56 only opens when a preset pressure is reached, which results in good quality extraction, especially when preparing a coffee.

After the pump 4 has delivered the amount of water required for the desired drink, it stops. The heating power of the heating element 9 is also switched off. Now the third valve 54 is opened first. Any pressure in the third fluid line 53 from the further access 25 can be discharged into the collection container 6. Then the second valve 52 is opened. The built-up pressure in the first fluid line 49, in particular in the hydraulic pressure piston 57, is thus discharged via the second valve 52 and the third valve 54 to the collection container 6. Since the first valve 50 is designed as a pressure valve, it will close immediately after the collapse of the excess pressure. Accordingly, no residue from the brewing chamber 3 can be washed into the second and third valves 52 and 54. As soon as the pressure in the antechamber 59 of the hydraulic pressure piston 57 decreases and the brewing chamber 3 is open, the latter moves back to its original position due to a return spring 46 and thereby pulls the injector plate 58 with its perforation means 32a away from the capsule 60.

As soon as the pressure in the beverage preparation machine is released, the movement of the brewing chamber halves 11 and 12 can be released again. When opening the brewing chamber 3, which can be done automatically or manually, the first brewing chamber half 11 moves from the closed position to the open position. The deformed and extracted capsule remains attached to the perforation means 32b of the second brewing chamber half 12. At the last moment of the opening movement, the ejector 30 is moved forward, i.e. towards the first brewing chamber half 11, so that it strips the capsule 60 from the perforation means 32b. At the same time as the ejector 30, the holding means 38 also move downwards again, so that a capsule 60 adhering to the ejector 30 is stripped off.

FIG. 10 shows a section through the closed brewing chamber 10 of the brewing unit 3 along the axis 16 from the first to the second brewing chamber half 11 and 12. The brewing chamber 3 has a brewing chamber surface 15 which, apart from the perforation means 32a and 32b and a possible groove, has no sharp edges or abrupt changes of direction. The brewing chamber surface 15 has a continuous curvature, the minimum radius of curvature being 3 mm. In the embodiment shown, the brewing chamber surface 15 has no flat surfaces.

The brewing chamber 15 is essentially rotationally symmetrical with the axis 16 as the axis of symmetry. The diameter transverse to the axis 16 is 32 mm. The brewing chamber 3 has a maximum extension 17 of 21.3 mm in the axial direction. In a central area, i.e. in the area of the axis 16, the brewing chamber 3 has a concave recess 20, so that the brewing chamber has a reduced thickness 19 of only 17 mm there. It has been shown that this shape of the brewing chamber 3 allows a compact of a spherical capsule 60 to be optimally broken up and extracted.

1.-16. (canceled)

17. A brewing chamber half for forming a brewing chamber with a corresponding second brewing chamber half of a brewing unit of a beverage preparation machine,
wherein the brewing chamber half has at least one of an inlet for introducing a brewing liquid for preparing a beverage or an outlet for discharging a prepared beverage,
wherein the brewing chamber half has at least one further access for at least one of introducing or discharging a rinsing liquid.

18. The brewing chamber half according to claim 17, wherein the further access comprises a filter element.

19. The brewing chamber half according to claim 17, wherein the brewing chamber half comprises an ejector for ejecting the capsule, said ejector designed to be movable relative to the brewing chamber half.

20. The brewing chamber half according to claim 19, wherein the further access is formed between the ejector and the brewing chamber half.

21. The brewing chamber half according to claim 18, wherein the filter element is formed as a gap,
wherein the gap is dimensioned such that no beverage substance can penetrate into the gap.

22. The brewing chamber half according to claim 20, wherein the further access comprises a filter element,
wherein the filter element is formed as an annular gap between the ejector and the brewing chamber half,
wherein the gap is dimensioned such that no beverage substance can penetrate into the gap.

23. The brewing chamber half according to claim 21, wherein the gap has a maximum width of 400 μm.

24. The brewing chamber half according to claim 22, wherein the gap has a maximum width of 400 μm.

25. The brewing chamber half according to claim 17, wherein the brewing chamber half comprises perforation means for perforating an inlet side or an outlet side of a capsule.

26. The brewing chamber half according to claim 25, wherein the perforation means are arranged movable relative to the brewing chamber half.

27. The brewing chamber half according to claim 25, wherein the brewing chamber half comprises an ejector for ejecting the capsule,
wherein the ejector is arranged movable relative to the perforation means.

28. A brewing unit of a beverage preparation machine,
said brewing unit having two corresponding brewing chamber halves which are movably arranged relative to each other to be brought from an open position for dispensing and inserting a capsule to a closed position for forming a brewing chamber and enclosing and extracting the capsule,
wherein at least one brewing chamber half has an inlet for introducing a brewing liquid for beverage preparation and at least one brewing chamber half has an outlet for discharging a prepared beverage,
wherein at least one brewing chamber half has at least one further access for at least one of introducing or discharging a rinsing liquid.

29. The brewing unit according to claim 28, wherein at least one of the brewing chamber halves comprises perforation means for perforating an inlet side or an outlet side of the capsule and an ejector for ejecting and stripping the capsule from the perforation means,
wherein the ejector is moveable relative to at least one of the brewing chamber halves or the perforation means,
wherein in the open position the ejector covers the perforation means in such a way that the perforation means does not project.

30. A method of ejecting a capsule from a brewing unit of a beverage preparation machine according to claim 28,
wherein upon relative movement of the brewing chamber halves from the closed position for forming a brewing chamber and for enclosing and extracting the capsule to the open position for ejecting and inserting the capsule in a first step the brewing chamber halves move away from each other and at least partially simultaneously, or subsequently, the perforation means moves relative to the ejector until it does not protrude.

31. The method of claim 30, wherein the ejector moves relative to the brewing chamber half such that it protrudes from a surface of the brewing chamber half.

32. The method of claim 30, wherein the ejector does not move relative to the brewing chamber half until the brewing chamber halves are nearly or fully in the open position.

33. The method of claim 30, wherein the ejector moves relative to the brewing chamber half only such that it does not protrude from the brewing chamber half.

34. A beverage preparation machine comprising a brewing unit according to claim 28.

35. A beverage preparation system comprising a capsule and a brewing unit according to claim 28.
